(19) United States
(12) Patent Application Publication
(10) Pub. No.: US 2002/0092362 A1
(43) Pub. Date: Jul. 18, 2002

(54) Flow-metering and sampling catch basin insert

(76) Inventors: Carl J. Tonge, Seabeck, WA (US); Joseph Francisco Zukauskas, Bremerton, WA (US)

Correspondence Address: Buchanan Ingersoll Professional Corporation, One Oxford Center, 20th Floor, 301 Grant Street, Pittsburgh, PA, 15219-1410, US

(21) Appl. No.: 09/761,381

(22) Filed: Jan. 16, 2001

(51) Int. Cl. G01F 1/00

(52) U.S. Cl. 73/861

(57) ABSTRACT

The present invention consists of a self-contained insert that can be placed within a catch basin or manhole in a closed conveyance stormwater drainage system. The device provides a means for isolating the water entering a catch basin from flows from other catch basins such that flow rate and water quality for water entering the catch basin can be measured, without contamination from flows from other catch basins. The device enables the use of various types of flow rate meters for determining the quantity of water passing into the catch basin and provides a volume of water from which samples may be collected for analysis of pollutant mass loading rates.

### FIELD OF THE INVENTION

This invention is related to the measurement of the flow of water, the instantaneous measurement of water quality, and the collection of samples of water for later laboratory analysis. In particular, the invention facilitates the collection of continuous water quality and flow rate data for stormwater runoff from localized geographical areas of concern, independent of the effects of the water or contaminants from other sources that may be present in an existing closed-conveyance drainage system.

### BACKGROUND OF THE INVENTION

There is a need, particularly at industrial sites, to measure the quantity and quality of storm runoff water. In particular, it is desired to accurately measure water quality parameters and the pollutant mass loading rates from closed-conveyance stormwater drainage systems. This is currently accomplished by measurements made at a system outfall of a closed-conveyance system, or at an upstream manhole located close to the outfall.

Pollutant mass loading rates for stormwater “hot spots” in inland areas served by closed-conveyance drainage systems are typically calculated based on water quality and flow measurements made at catch basins (or manholes) located upstream and downstream from the catch basin of interest.

A typical storm catch basin consists of a box buried below ground level topped by a metal grate through which stormwater enters the basin. The box typically has one outlet pipe, but can also have one or more inlet pipes from upstream catch basins.

Flow measuring devices can be placed at the outlet pipe and at each of the inlet pipes, or at the outlet pipes of upstream catch basins. In this way, the amount of water entering any particular catch basin from the surface can be calculated by subtracting the volume at each of the inlet pipes from the volume at the outlet pipe.

To make measurements of water quality, the current practice is to take samples from within the catch basin. One problem with this approach is that the water in any particular catch basin may be contaminated with water entering that basin from upstream catch basins, making it impossible to determine which or what quantity of pollutants are entering the drainage system through any particular catch basin. Therefore it would be desirable to be able to measure the volume and quality of water actually flowing into the catch basin, instead of merely calculating the volume and quality measurements at any particular catch basin based on measurements from several other catch basins. Further, it would be desirable to be able to measure the quality of the water at any particular catch basin with respect to the water actually flowing into that basin, to better identify the source of any detected pollutants.

A further difficulty associated with the current state of the practice is that, for drainage systems found in close proximity to a waterfront, the measurements are often influenced by tidal cycles that periodically back-flood the outfall pipe. In such an environment, sampling might be performed during low tides, but this strategy does not address the problem of measurement errors due to the presence of contaminants from past practices or events rather than only from recent storm events. It would therefore be desirable to eliminate this problem by taking measurements as the water enters the catch basin, thereby eliminating errors from the backup of tidal waters.

For inland drainage systems, the current state of the practice may also result in significant measurement errors due the presence of non-stormwater flows and contaminants from past practices in an existing drainage system. In addition, this common approach for determining the pollutant loading to an inland drainage system “node” requires approximately twice the amount of field equipment and chemical analysis (at twice the cost) as measuring water quality and flow parameters of the runoff directly at one location. Lastly, installation of equipment for the approach of the current state of the practice often involves expensive confined space entry work in manholes. It would be desirable to eliminate these unattractive features of the current practice.

### SUMMARY OF THE INVENTION

The present invention consists essentially of a self-contained insert that can be placed within a catch basin or manhole in a closed conveyance stormwater drainage system. Installation of the device is accomplished by first removing the existing inlet grate and lowering the unit into the hole. A collar on the top edge of the device is designed to make contact with the catch basin rim at the point where the grate previously rested.

The device operates by intercepting the stormwater runoff entering the catch basin in a sump box, which also serves as a sampling and grit removal chamber, and then routing the runoff through an S-trap assembly. Continuous water quality measurements can be made using field instruments deployed in the sump box and/or by the collection of liquid samples using an automated liquid sampling device. Grab samples can also be collected manually from the sump box. Water quality measurements on collected liquid samples can be made at a chemical analytical laboratory.

The device intercepts stormwater runoff in the form of sheet or shallow concentrated flow and routes it through the S-trap assembly. Continuous flow rate measurements are made using an externally mounted, clamp-on, collar-type electronic pipe flow meter installed on a linear pipe segment of the S-trap assembly. It is desirable that the section of pipe to which the flow meter is connected be maintained in a full condition, even when there is no flow, to avoid having to re-calibrate the flow meter.

Using the device, water quality and flow measurements are made on stormwater runoff before it falls down into the sump of an existing catch basin, where it can mingle with other contaminants and/or flows that may be present there. Water quality and flow data collected using the device are not biased or confounded by the effects of other contaminants or flows that may be present in the sump of an existing catch basin.

### BRIEF DESCRIPTION OF THE DRAWINGS

FIG. 1 is an outside side view of the device of the current invention.

FIG. 2 is an outside side view rotated 90° from the view of FIG. 1.

FIG. 3 is a top view of the device of the current invention.

FIG. 4 shows the device inserted in its operating environment with the associated equipment.

### DETAILED DESCRIPTION OF THE INVENTION

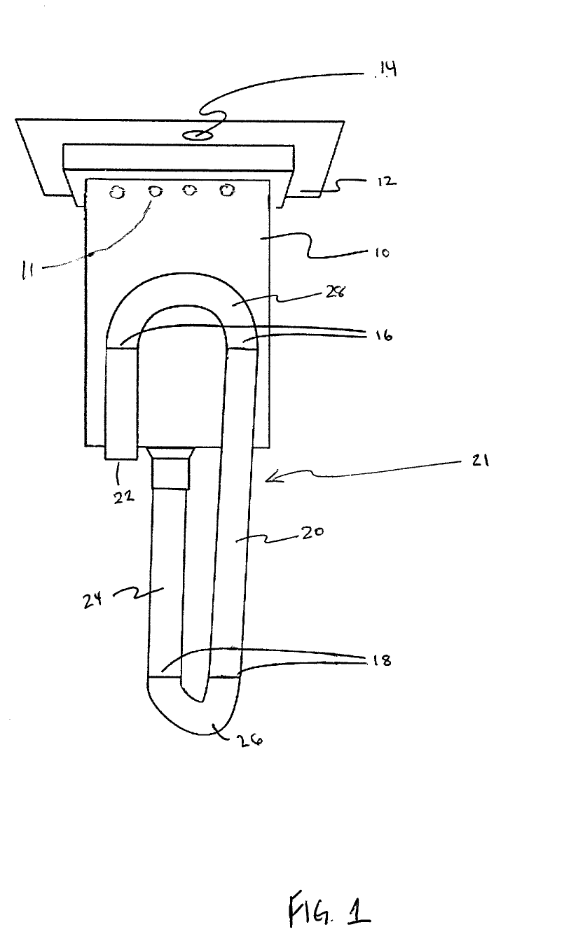

The device of the current invention consists of three main assemblies best shown in FIGS. 1-3. These are the sump box 10, an S-trap assembly 21 and a sump box collar support 12.

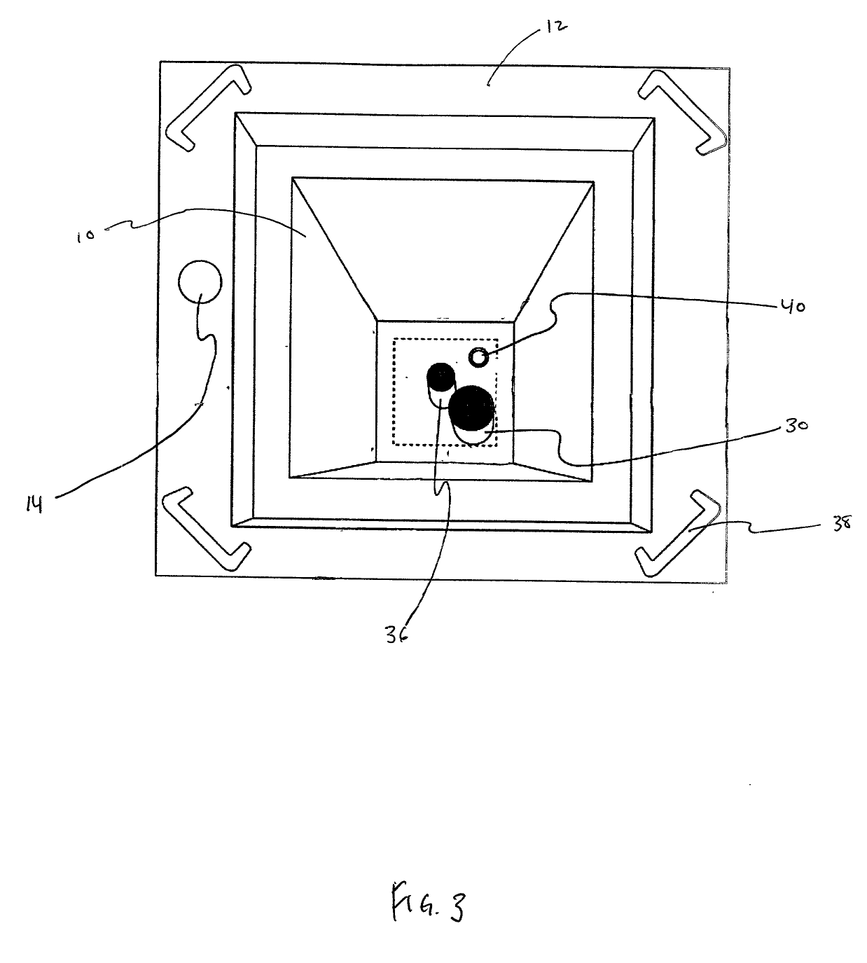

In operation, water enters the top of the device, shown in FIG. 3, and collects in sump box 10 until reaching the level of the top of inlet pipe 36 to S-trap assembly 21. In the preferred embodiment, the water then flows through straight section 24 of S-trap assembly 21, through 180° bend 26, up straight section 20, and out opening 22. The S-trap assembly, best shown in FIG. 1, may be of any configuration having a straight section of pipe that can always be kept filled with water, even in a zero flow condition. The downward flow of the water in section 24 reduces the bubbles and floatable solids known to contribute errors to flow measurements using acoustical or electromagnetic pipe flow meters. As the water is conducted upward through the second straight pipe section 20, the flow measurement is taken. An acoustical (e.g. ultrasonic) or electromagnetic flow meter can be clamped near the middle of segment 20, but should be placed at a level where pipe section 20 is continuously full of water, even in zero flow conditions. The straight pipe segments that lie upstream and downstream of the sensor must be of a certain minimum diameter to ensure a flow of water adequate for accurate measurements and for the correct operation of the flow sensor. Required flow velocity information is provided by manufacturers of the flow sensors, which are well known in the art. After water exits S-trap assembly 21 through opening 22, it falls into the existing catch basin and into the closed conveyance system into which the device has been inserted. Note that the portion of S-trap assembly 21 after straight section 20 may be of any shape designed to direct the flow of water away from the top of straight section 20 and into catch basin. 7

One problem arising with the use of the device happens with localized flooding which could arise in the event of a storm event that produces greater than the maximum flow that S-trap assembly 21 is designed to handle. S-trap assembly 21 can be produced in various sizes that can easily be interchanged to pass various design flows. The size of S-trap assembly 21 for a particular application (location) should be large enough to provide the desired level of protection from localized flooding using appropriate hydrological and hydraulic engineering methods. Strap assembly 21 for a particular application should also be sized to provide for a minimum time average flow velocity, if required by the manufacturer of the flow meter. Regardless of the maximum flow that any flow-through stormwater drainage structure is designed to pass, there will always be the possibility that a larger storm will occur that will exceed the capacity of the structure.

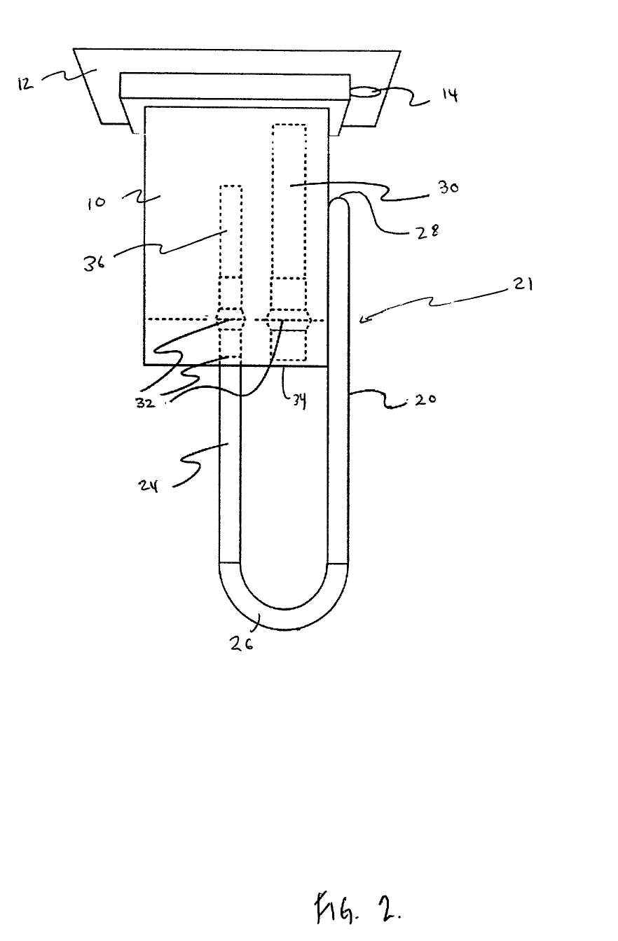

A second problem that could arise is that the pressure of air or water at outlet 22 of S-trap assembly 21 could exceed atmospheric pressure sufficiently to reduce the flow of water through the device. This condition can cause the device to float up out of the catch basin, resulting in a safety hazard. Vent holes 11, shown in FIG. 1 reduce the potential for this problem by allowing liquid and gasses to pass freely in both directions. In an alternate embodiment, overflow bypass pipe 30, shown in FIGS. 2 and 3 serves the same purpose. Overflow bypass pipe 30 is a section of straight pipe that extends upward through the bottom of sump box 10 to a level near the top of sump box 10. Overflow bypass pipe 30 can be supplied with fittings such that it can be converted into a second complete S-trap assembly and fitted with a separate flow sensor.

Sump box 10 may be equipped with drain plug 40 in the base thereof to allow the draining of liquid to reduce the gross weight of the device prior to deinstallation.

In the preferred embodiment, sump box 20 can be supplied with fittings 32 that permit easy reconfiguration with S-trap assemblies 21 of varying sizes, which will allow the realization of flow velocities in a range that will ensure accurate volumetric flow rate measurement, while minimizing the potential of water backing up and flooding the area around the catch basin. For obvious reasons, S-trap outflow pipe 24 and bypass pipe 30 must be sealed at the point where they penetrate the bottom of sump box 10.

In another embodiment, sump box 10 is able to be configured with multiple S-trap assemblies 21. The elevations of the inlet pipes 36 for each S-trap assembly should be staggered in height. In the staggered, multiple S-trap configuration, water entering sump box 10 will first flow through the S-trap having its inlet opening set lowest. Sump box 10 may contain multiple plugs of various sizes to facilitate the configuration of the sump box with multiple S-trap assemblies 21 having various diameters.

When configured with multiple S-trap assemblies 21 having different diameters, the inlet of the S-trap assembly 21 having the smallest diameter pipe can be set at the lowest elevation possible within sump box 10. In the event the flow into sump box 10 exceeds the capacity of the S-trap assembly 21 having its outlet at the lowest level, the water level in sump box 10 will rise and enter the next highest S-trap assembly 21. Sump box 10 can be configurable with two or three S-trap pipe assemblies 21 with different size pipe arranged with their inlet openings staggered vertically in this manner. A multiple S-trap assembly configuration may be needed to achieve the desired balance between maximum flow capacity and time averaged flow velocity.

Passing the flow through a smaller diameter S-trap assembly 21 provides for higher velocity compared to passing the same quantity of water through a larger diameter S-trap assembly 21. Within any given time interval, the total time during which flow velocities exceed the minimum required for accurate flow measurements with the collar type flow meter (as specified by the manufacturer of the flow meter) can be increased by proper configuration of one or multiple S-trap assemblies 21. Increasing the total time during which flow velocity exceeds the minimum required for accurate flow measurement over a given time interval can effectively increase the overall accuracy of flow measurement on a volume basis where low flows are expected to be significant.

Configuration of the device with multiple S-trap assemblies 21 would involve equipping each S-trap assembly 21 with a separate flow sensor connected to a separate data logger unit, or to a partition within in a single data logger unit. The total flow through the catch basin insert at any instant would then be computed as the sum of the flows through all of S-trap assemblies 21. A potential drawback of using multiple S-trap assemblies 21 is the additional effort involved in processing the data. Instantaneous flow data from multiple sensors would need to be added at each time that flow is measured to obtain a record of a total flow through the device. Configuration with multiple S-trap assemblies 21 might be desirable in situations in which time average flow rates associated with significant proportions of the total run off volume are expected to fall within multiple ranges.

Water samples for quality analysis can be obtained directly from sump box 10. Sump box 10 should be sized to provide a sufficient dead liquid storage volume (i.e., volume below the height of the lowest inlet opening 36 of an S-trap assembly 21) such as to serve both as a grit removal chamber and a sampling chamber. On the other hand, sump box 10 must be small enough to allow the device to fit in to the catch basins into which it is to be installed. The depth of sump box 10 should be sufficient to house a multiple parameter water quantity probe 40 and/or other water quality field instruments or sampling devices with their sensors submerged within the dead liquid storage volume area (i.e., the sampling chamber).

Insert flange 12 should be recessed to allow the existing catch basin inlet grate to be replaced over the device after it has been installed in the catch basin. The recess should be deep enough to accommodate counterweights or stiffening members that are sometimes provided on the lower surfaces of inlet grates. Insert collar 12 supports sump box 10 from the catch basin rim and should be removable and interchangeable with a set of insert collars sized to various sizes of catch basin rims into which the device may potentially be inserted. Preferably, the interchangeable insert collar 12 and sump box 10 shall be made of stainless steel of a gauge sufficient to support at a minimum the weight of the unit filled to overflowing with water plus the weight of all instruments or other equipment to be housed inside the sump box plus an additional safety factor. Alternately, these components can be constructed from aluminum or plastic. Although shown in the drawings in a rectangular shaped format, sump box 10 may be of any convenient shape, such as a circular, to allow accommodation by catch basins of different shapes.

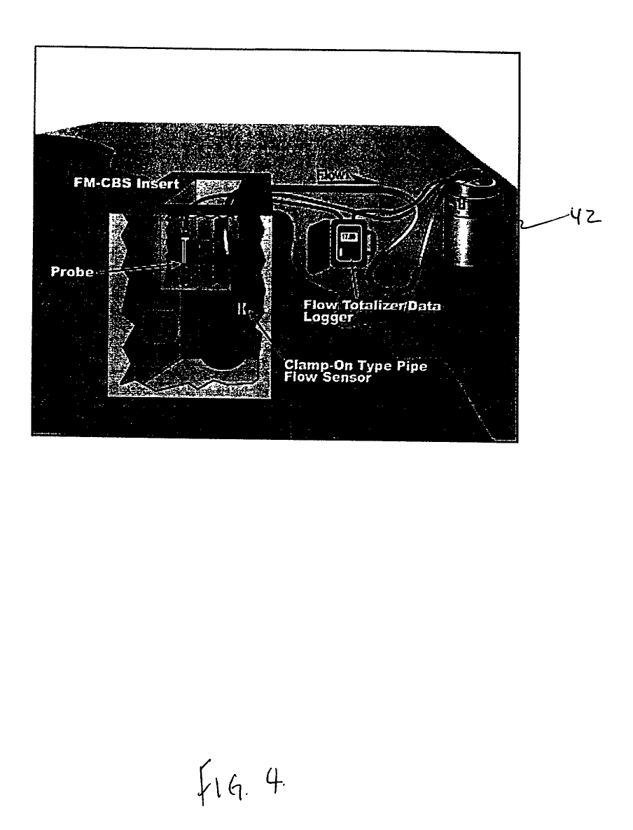

A typical field setup of the device is illustrated in FIG. 4. The device may be equipped with an automatic water sampler of a type well known in the art. Additionally, the device may be equipped with an on-site water quality analyzer of a type well known in the art. Access hole 14 in collar 12 allows access for cables necessary for flow rate meters attached to the outsides of Strap assemblies 21. Note that both the automated liquid sampler and electronic clamp-on type pipe flow meters are existing, off-the shelf technologies available commercially from several manufacturers.

The scope of the invention is embodied in the claims which follow and is not meant to be limited by any example provided herein as illustration of various embodiments of the invention.

We claim:

1. A catch basin insert comprising:
a sump box having a bottom and one or more sides extending upwardly therefrom, said sump box defining an orifice in the bottom thereof; and
a pipe assembly having an inlet opening on one end for receiving water from said orifice,
and an outlet opening on the opposite end, said pipe assembly having at least one straight section that is always full of water.

2. The catch basin of claim 1 wherein said inlet opening of said pipe assembly extends through said orifice in the bottom of said sump box and rests above said bottom of said sump box.

3. The device of claim 1 further comprising a collar, attached to said sides of said sump box and extending outwardly therefrom.

4. The device of claim 3 further comprising a plurality of handles, attached to said collar.

5. The device of claim 1 wherein said pipe assembly comprises:
a first straight section, extending through said orifice and defining said inlet opening in one end thereof;
a U-shaped section, attached to said first straight section opposite said inlet opening;
a second straight section, connected to said U-shaped section opposite said first straight section; and
a section, attached to said second straight section opposite said U-shaped section, for directing water away from the top of said second straight section.

6. The device of claim 1 further comprising a means for allowing liquids and gasses to flow between said sump box and a catch basin into which said device is inserted.

7. The device of claim 6 wherein said means for allowing liquids and gasses to flow between said sump box and said catch basin comprises one or more vent holes defined in said one or more sides of said sump box.

8. The device of claim 6 wherein said means for allowing liquids and gasses to flow between said sump box and said catch basin comprises a bypass pipe, extending through an orifice defined in said bottom of said sump box.

9. The device of claim 1 wherein said bottom of said sump box defines a drain hole and further comprising a removable drain plug, for plugging said drain hole.

10. The device of claim 1 further comprising a means for measuring the flow of water through said pipe assembly.

11. The device of claim 10 wherein said means for measuring is selected from a group comprising an acoustical flow meter and an electromagnetic flow meter.

12. The device of claim 2 wherein a predetermined volume of water is collected in said sump box before said water flows into said inlet opening.

13. The device of claim 12 further comprising one or more water sampling devices for collecting water samples from said volume of water in said sump box.

14. The device of claim 1 wherein the shape of the cross section of said stump box is selected from a group comprising rectangular and circular.

15. The device of claim 3 wherein said collar is detachable from said sump box such that collars of varying sizes may be attached.

16. The device of claim 4 wherein said collar and said handles are composed of a material selected from a group comprising stainless steel, aluminum and plastic.

17. The device of claim 1 wherein said sump box is composed of a material selected from a group comprising stainless steel, aluminum and plastic.

18. A catch basin insert comprising:
a sump box having a bottom and one or more sides extending upwardly therefrom, said sump box defining a plurality of orifices in the bottom thereof; and
a plurality of pipe assemblies, each having an inlet opening on one end and an outlet opening on the opposite end, each of said pipe assemblies extending through one of said orifices such that said inlet opening extends through said orifice and rests above said bottom of said sump box;
wherein each of said pipe assemblies have at least one straight section that is always full of water.

19. The device of claim 18 wherein each of said inlet openings for said pipe assemblies extends a different height above said bottom of said sump box.

20. The device of claim 19 wherein each of said pipe assemblies are sized such as to maintain a minimum flow velocity of liquid necessary for accurate flow measurements.

21. The device of claim 18 further comprising a collar, attached to said sides of said sump box and extending outwardly therefrom.

22. The device of claim 21 further comprising a plurality of handles, attached to said collar.

23. The device of claim 18 wherein each of said pipe assemblies comprises:
a first straight section, extending through one of said orifices and defining said inlet opening in one end thereof;
a U-shaped section, attached to said first straight section opposite said inlet opening;
a second straight section, connected to said U-shaped section opposite said first straight section; and
a section, attached to said second straight section opposite said U-shaped section, for directing water away from the top of said second straight section.

24. The device of claim 18 further comprising a means for allowing liquids and gasses to flow between said sump box and a catch basin into which said device is inserted.

25. The device of claim 24 wherein said means for allowing liquids and gasses to flow between said sump box and said catch basin comprises one or more vent holes defined in said one or more sides of said sump box.

26. The device of claim 24 wherein said means for allowing liquids and gasses to flow between said sump box and said catch basin comprises a bypass pipe, extending through an orifice defined in said bottom of said sump box.

27. The device of claim 18 wherein said bottom of said sump box defines a drain hole and further comprising a removable drain plug, for plugging said drain hole.

28. The device of claim 23 further comprising a means for measuring the flow of water through said plurality of pipe assemblies.

29. The device of claim 28 wherein said means for measuring is selected from a group comprising an acoustical flow meter and an electromagnetic flow meter.

30. The device of claim 18 wherein a predetermined volume of water is collected in said sump box before said water flows into said inlet opening.

31. The device of claim 30 further comprising one or more water sampling devices for collecting water samples from said volume of water in said sump box.

32. The device of claim 18 wherein the shape of the cross section of said sump box is selected from a group comprising rectangular and circular.

33. The device of claim 21 wherein said collar is detachable from said sump box such that collars of varying sizes may be attached.

34. The device of claim 22 wherein said collar and handles are composed of a material selected from a group comprising stainless steel, aluminum and plastic.

35. The device of claim 18 wherein said sump box is composed of a material selected from a group comprising stainless steel, aluminum and plastic.
